(19) United States
(12) Patent Application Publication
(10) Pub. No.: US 2023/0029840 A1
(43) Pub. Date: Feb. 2, 2023

(54) METHOD OF POST TREATMENT OF THREE-DIMENSIONAL PRINTED OBJECT

(71) Applicant: HEWLETT-PACKARD DEVELOPMENT COMPANY, L.P., SPRING, TX (US)

(72) Inventors: EMRE DISCEKICI, SAN DIEGO, CA (US); ALAY YEMANE, SAN DIEGO, CA (US); SHANNON R. WOODRUFF, SAN DIEGO, CA (US)

(21) Appl. No.: 17/381,947

(22) Filed: Jul. 21, 2021

(51) Int. Cl. B29C 64/30; B33Y 80/00; B33Y 40/20; B29C 71/02

(52) U.S. Cl. CPC B29C 64/30; B33Y 80/00; B33Y 40/20; B29C 71/02; B29K 2077/00

(57) ABSTRACT

The present disclosure describes a method of post-treatment of a three-dimensional printed object and the three-dimensional printed object thus produced from this method. The method of post-treatment comprises application of a post-treatment agent comprising a plant oil and a heat-treatment step at high temperature with the aim of reducing surface roughness of the final part.

### BACKGROUND

Three-dimensional (3D) printing is a term synonymous with additive manufacturing describing a method and system which builds three-dimensional objects from the selective addition of a build material. This is in contrast to traditional machining processes which usually rely on the removal of material to create the final part. Some 3D printing methods use chemical binders or adhesives to bind build material while other 3D printing methods involve at least partial curing, fusing or melting of build material. Limitations imposed by the range of materials that can be used in the systems makes it a challenge to print functional parts with desired mechanical and aesthetic properties.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIGS. 1A-1C are schematic views of an example three-dimensional printing system in accordance with the present disclosure;

FIG. 2 is a schematic view of an example three-dimensional printed object being treated with a post-treatment agent in accordance with the present disclosure.

FIG. 3 is a cross-sectional view of an example three-dimensional printed object prepared in accordance with the present invention.

FIG. 4 is an example three-dimensional printing method followed by application of a post-treatment agent in accordance with the present disclosure.

FIG. 5 is an example of the post-treatment process following three-dimensional printing of an object of the present disclosure.

FIG. 6 is a schematic view of an example three-dimensional printing kit in accordance with the present disclosure.

### DETAILED DESCRIPTION

The present disclosure describes a method of post-treatment of a three-dimensional printed object, the three-dimensional printed object thus produced from this method and a three-dimensional printing kit

Three-dimensional printing (also often referred to as 3D Printing or additive manufacturing) is a method by which a three-dimensional object is created by the successive addition of build material in liquid, viscous, solid or powder form. There are a number of known methods by which this is accomplished, One such method utilizes build material in the form of a powder which is selectively solidified by means of sintering, melting fusing or binding of the particles together

Once printed the unsolidified powder is removed to reveal a final three-dimensional printed object. The three-dimensional printed object can then be post-treated by a number of methods. For example, the polishing of the three-dimensional printed part can decrease the surface roughness of the part.

The present disclosure describes a method of post-treatment of a three-dimensional printed object with the aim of improving the appearance by reducing the surface roughness of the object. In another example of the current disclosure improvements may also be realized in terms of mechanical properties.

The build material used to make three-dimensional printed objects by this manner can include a particulate build material comprising a polymeric material. The particulate build material is applied in a thin layer and onto this is further applied a fusing agent comprising a radiation absorber. Subsequent to the fusing agent's application to the particulate build material, the particulate build material is exposed to a source of radiation and the particulate build material is fused. Fusing is the process by which the particulate build material is heated above the glass transition temperature and more preferably above the melting point of the build material such that build material melts and fuses. The fusing agent comprising a radiation absorber facilitates the fusing process.

Particulate Build Materials

Particulate build materials suitable in the present disclosure can include polymeric particles such as, but not limited to, thermoplastic amide (TPA). In the present case TPA is an elastomeric polyamide copolymer. In some examples, TPA comprises a block copolymer comprising a hard block and a soft block. In some examples, TPA is a block copolymer comprising a polyamide block and a polyether block. In another example the particulate build materials may include polyamides such as polyamide-12, polyamide-6, polyamide-66, polyamide-69, polyamide 6-10, polyamide 6-12, polyamide-46, polyamide-1212 and combinations thereof.

In further detail regarding the particulate build material, this material can include particles having a variety of shapes, such as substantially spherical particles or irregularly-shaped particles. In some examples, the TPA particles can be capable of being formed into three-dimensional printed objects with a resolution of about 20 μm to about 300 μm, about 30 μm to about 90 μm, or about 40 μm to about 80 μm. As used herein, “resolution” refers to the size of the smallest feature that can be formed on a three-dimensional printed object. The TPA particles can form layers from about 20 μm to about 300 μm thick, allowing the fused layers of the printed part to have roughly the same thickness. This can provide a resolution in the z-axis (i.e., depth) direction of about 20 μm to about 300 μm. The TPA particles can also have a sufficiently small particle size and sufficiently regular particle shape to provide about 20 μm to about 100 μm resolution along the x-axis and y-axis (i.e., the axes parallel to the top surface of the powder bed). For example, the TPA particles can have a volume average particle size from about 20 μm to about 100 μm. In other examples, the volume average particle size can be from about 60 μm to about 90 μm.

In some examples the particulate build material may be in the form of a powder. In another example the particulate build material may be in the form of, formed from, or may include, short fibers that may, for example, have been cut into short lengths from long strands or threads of material. In one example these short fibers can have a length of about 20 μm to about 100 μm. In another example, the length of these short fibers can be from about 60 μm to about 90 μm and can have an aspect ratio of approximately 1:1.

As an example of polymeric build materials having utility in the present disclosure the TPA particles can have a melting temperature from about 140° C. to about 155° C.

As an example of polymeric build materials having utility in the present disclosure, polyamide-12 particles can have a melting or softening point from about 175° C. to about 200° C. If other polymeric particles are included in the particulate build material, e.g., blended or composited with the polyamide-12 particles, examples of materials that may be present include particles of polyamide-6, polyamide-9, polyamide-11, polyamide-6,6, polyamide-6,12, polyamide copolyamide-12, polyethylene, wax, thermoplastic polyurethane, acrylonitrile butadiene styrene, amorphous polyamide, polymethylmethacrylate, ethylene-vinyl acetate, polyarylate, aromatic polyesters, silicone rubber, polypropylene, polyester, polycarbonate, copolymers of polycarbonate with acrylonitrile butadiene styrene, copolymers of polycarbonate with polyethylene terephthalate, polyether ketone, polyacrylate, polystyrene, polyvinylidene fluoride, polyvinylidene fluoride copolyamide-12, poly(vinylidene fluoride-trifluoroethylene), poly(vinylidene fluoride-trifluoroethylene-chlorotrifluoroethylene), or mixtures thereof. If a second type of polymer particle is included, in one example, the majority of the polymeric particles present can be polyamide-12, e.g., greater than 50 wt % of the polymer particles present in the particulate build material is polyamide-12. In other examples, when multiple polymer particles are used, a weight ratio of polyamide-12 to all other polymer particles present can be from about 100:1 to about 1:1, or from about 20:1 to about 2:1, for example.

The TPA particles can also in some cases be blended with a non-polymeric filler. The filler can include inorganic particles such as alumina, silica, fibers, carbon nanotubes, or combinations thereof. When the TPA particles fuse together, the filler particles can become embedded in the polymer forming a composite material. In some examples, the filler can include a free-flow agent, anti-caking agent, or the like. Such agents can prevent packing of the powder particles, coat the powder particles and smooth edges to reduce inter-particle friction, and/or absorb moisture. In further examples, a filler can be encapsulated in polymer to form polymer encapsulated particles. For example, glass beads can be encapsulated in a polymer such as a polyamide to form polymer encapsulated particles. In some examples, a weight ratio of thermoplastic polymer to filler in the particulate build material can be from about 100:1 to about 1:2 or from about 5:1 to about 1:1,

Fusing Agent

The fusing agents can be applied to the particulate build material in areas that are to be fused together during three-dimensional printing. The fusing agent includes a radiation absorber. The fusing agent can include carbon black pigment particles as the radiation absorber. The carbon black pigment particles can absorb radiant energy and convert the energy to heat. As explained above, the fusing agent can be used with a particulate build material in a particular three-dimensional printing process. A thin layer of particulate build material can be formed, and then the fusing agent can be selectively applied to areas of the particulate build material that are desired to be consolidated to become part of the solid three-dimensional printed object. The fusing agent can be applied, for example, by printing such as with a fluid ejector or fluid jet printhead. Fluid jet printheads can jet the fusing agent in a similar way as an inkjet printhead jetting printing liquid. Accordingly, the fusing agent can be applied with great precision to certain areas of the particulate build material that are desired to form a layer of the final three-dimensional printed object. After applying the fusing agent, the particulate build material can be irradiated with radiant energy. The carbon black pigment particles from the fusing agent can absorb this radiation and convert it to heat, thereby heating any particles in contact with the pigment particles. An appropriate amount of radiant energy can be applied so that the area of the particulate build material that was printed with the fusing agent heats up enough to melt the particles to consolidate the particles into a solid layer, while the particulate build material that was not printed with the fusing agent remains as a loose powder with separate particles.

In some examples, the amount of radiant energy applied, the amount of fusing agent applied to the build material, the concentration of radiation absorber in the fusing agent, and the preheating temperature of the powder bed (e.g., the temperature of the particulate build material prior to printing the fusing agent and irradiating) can be tuned to ensure that the portions of the powder bed printed with the fusing agent will be fused to form a solid layer and the unprinted portions of the powder bed will remain a loose powder. These variables can be referred to as parts of the “print mode” of the three-dimensional printing system. The print mode can include any variables or parameters that can be controlled during three-dimensional printing to affect the outcome of the three-dimensional printing process.

The process of forming a single layer by applying fusing agent and irradiating the powder build material can be repeated with additional layers of fresh particulate build material to form additional layers of the three-dimensional printed object, thereby building up the final object one layer at a time. In this process, the particulate build material surrounding the three-dimensional printed object can act as a support material for the object. When the three-dimensional printing is complete, the article can be removed from the powder bed and any loose powder on the article can be removed.

Accordingly, in some examples, the fusing agent can include a radiation absorber that is capable of absorbing electromagnetic radiation to produce heat. The radiation absorber can include carbon black pigment particles. These particles can effectively absorb radiation to generate heat. The particles also give the finished three-dimensional printed object a black appearance. In alternative examples, other radiation absorbers may be included. The radiation absorber can be colored or colorless. In various examples, the radiation absorber can include carbon black pigment, metal dithiolene complex, a near-infrared absorbing dye, a near-infrared absorbing pigment, metal nanoparticles, a conjugated polymer, tungsten bronze, molybdenum bronze, or a combination thereof. Examples of near-infrared absorbing dyes include aminium dyes, tetraaryldiamine dyes, cyanine dyes, phthalocyanine dyes, dithiolene dyes, and others. In further examples, the radiation absorber can be a near-infrared absorbing conjugated polymer such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds. In many cases, the radiation absorber can have a peak absorption wavelength in the range of about 800 nm to about 1400 nm.

A variety of near-infrared pigments can also be used, Non-limiting examples can include phosphates having a variety of counterions such as copper, zinc, iron, magnesium, calcium, strontium, the like, and combinations thereof. Non-limiting specific examples of phosphates can include M₂P₂O₇, M₄P₂O₉, M₅P₂O₁₀, M₃(PO₄)₂, M(PO₃)₂, M₂P₄O₁₂, and combinations thereof, where M represents a counterion having an oxidation state of +2, such as those listed above or a combination thereof. For example, M₂P₂O₇ can include compounds such as Cu₂P₂O₇, Cu/MgP₂O₇, Cu/ZnP₂O₇, or any other suitable combination of counterions. It is noted that the phosphates described herein are not limited to comprising counterions having a +2 oxidation state. Other phosphate counterions can also be used to prepare other suitable near-infrared pigments.

Additional near-infrared pigments can include silicates, Silicates can have the same or similar counterions as phosphates. One non-limiting example can include M₂SiO₄, M₂Si₂O₆, and other silicates where M is a counterion having an oxidation state of +2. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the silicates described herein are not limited to comprising counterions having a +2 oxidation state. Other silicate counterions can also be used to prepare other suitable near-infrared pigments.

In further examples, the radiation absorber can include a metal dithiolene complex. Transition metal dithiolene complexes can exhibit a strong absorption band in the 600 nm to 1600 nm region of the electromagnetic spectrum. In some examples, the central metal atom can be any metal that can form square planar complexes. Non-limiting specific examples include complexes based on nickel, palladium, and platinum.

In further examples, the radiation absorber can include a tungsten bronze or a molybdenum bronze. In certain examples, tungsten bronzes can include compounds having the formula MₓWO₃, where M is a metal other than tungsten and x is equal to or less than 1. Similarly, in some examples, molybdenum bronzes can include compounds having the formula MₓMoO₃, where M is a metal other than molybdenum and x is equal to or less than 1.

A dispersant can be included in the fusing agent in some examples. Dispersants can help disperse the radiation absorbing pigments described above. In some examples, the dispersant itself can also absorb radiation, Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, sodium polymethacrylate and combinations thereof.

The amount of radiation absorber in the fusing agent can vary depending on the type of radiation absorber. In some examples, the concentration of radiation absorber in the fusing agent can be from about 0.1 wt % to about 20 wt %. In one example, the concentration of radiation absorber in the fusing agent can be from about 0.1 wt % to about 15 wt %. In another example, the concentration can be from about 0.1 wt % to about 8 wt %. In yet another example, the concentration can be from about 0.5 wt % to about 2 wt %. In a particular example, the concentration can be from about 0.5 wt % to about 1.2 wt %. In one example, the radiation absorber can have a concentration in the fusing agent such that after the fusing agent is jetted onto the particles, the amount of radiation absorber in the particles can be from about 0.0003 wt % to about 10 wt %, or from about 0.005 wt % to about 5 wt %, with respect to the weight of the polymeric build material.

In some examples, the fusing agent can be jetted onto the polymeric build material using a fluid jetting device, such as inkjet printing architecture. Accordingly, in some examples, the fusing agent can be formulated to give the fusing agent good jetting performance, Ingredients that can be included in the fusing agent to provide good jetting performance can include a liquid vehicle. Thermal jetting can function by heating the fusing agent to form a vapor bubble that displaces fluid around the bubble, and thereby forces a droplet of fluid out of a jet nozzle. Thus, in some examples the liquid vehicle can include a sufficient amount of an evaporating liquid that can form vapor bubbles when heated. The evaporating liquid can be a solvent such as water, an alcohol, an ether, or a combination thereof.

In some examples, the liquid vehicle formulation can include a co-solvent or co-solvents present in total at from about 1 wt % to about 50 wt %, depending on the jetting architecture. Further, a non-ionic, cationic, and/or anionic surfactant can be present, ranging from about 0.01 wt % to about 5 wt %. In one example, the surfactant can be present in an amount from about 1 wt % to about 5 wt %. The liquid vehicle can include dispersants in an amount from about 0.5 wt % to about 3 wt %. The balance of the formulation can be purified water, and/or other vehicle components such as biocides, viscosity modifiers, material for pH adjustment, sequestering agents, preservatives, and the like. In one example, the liquid vehicle can be predominantly water.

In some examples, a water-dispersible or water-soluble radiation absorber can be used with an aqueous vehicle, Because the radiation absorber is dispersible or soluble in water, an organic co-solvent may not be present, as it may not be included to solubilize the radiation absorber. Therefore, in some examples the fluids can be substantially free of organic solvent, e.g., predominantly water. However, in other examples a co-solvent can be used to help disperse other dyes or pigments or enhance the jetting properties of the respective fluids. In still further examples, a non-aqueous vehicle can be used with an organic-soluble or organic-dispersible fusing agent.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol, 1,2-propanediol, and 1,5-pentanediol.

In certain examples, a high boiling point co-solvent can be included in the fusing agent. The high boiling point co-solvent can be an organic co-solvent that boils at a temperature higher than the temperature of the powder bed during printing. In some examples, the high boiling point co-solvent can have a boiling point above about 250° C. In still further examples, the high boiling point co-solvent can be present in the fusing agent at a concentration from about 1 wt % to about 4 wt %.

In certain examples, the fusing agent can include a polar organic solvent. As used herein, “polar organic solvents” can include organic solvents made up of molecules that have a net dipole moment or in which portions of the molecule have a dipole moment, allowing the solvent to dissolve polar compounds. The polar organic solvent can be a polar protic solvent or a polar aprotic solvent. Examples of polar organic solvents that can be used can include diethylene glycol, triethylene glycol, tetraethylene glycol, C3 to C6 diols, 2-pyrrolidone, hydroxyethyl-2-pyrrolidone, 2-methyl-1,3 propanediol, poly(propylene glycol) with 1, 2, 3, or 4 propylene glycol units, glycerol, and others. In some examples, the polar organic solvent can be present in an amount from about 0.1 wt % to about 20 wt % with respect to the total weight of the fusing agent.

Regarding the surfactant that may be present, a surfactant or surfactants can be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the fusing agent may range from about 0.01 wt % to about 20 wt %. Suitable surfactants can include, but are not limited to, liponic esters such as TERGITOL™ ™ 15-S-12, TERGITOL™ 15-S-7 available from Dow Chemical Company (Michigan), LEG-1 and LEG-7; TRITON™ X-100; TRITON™ X-405 available from Dow Chemical Company (Michigan); and sodium dodecyl sulfate.

Various other additives can be employed to enhance certain properties of the fusing agent for specific applications. Examples of these additives are those added to inhibit the growth of harmful microorganisms. These additives may be biocides, fungicides, and other microbial agents, which can be used in various formulations. Examples of suitable microbial agents include, but are not limited to, NUOSEPT® (Nudex, Inc., New Jersey), UCARCIDE™ (Union carbide Corp., Texas), VANCIDE® (R.T. Vanderbilt Co., Connecticut), PROXEL® (ICI Americas, New Jersey), and combinations thereof.

Sequestering agents, such as EDTA (ethylene diamine tetra acetic acid), may be included to eliminate the deleterious effects of heavy metal impurities, and buffer solutions may be used to control the pH of the fluid. From about 0.01 wt % to about 2 wt % of each of these additives (based on the total formulation weight), for example, can be used. Viscosity modifiers and buffers may also be present, as well as other additives to modify properties of the fluid as desired. Such additives can be present at from about 0.01 wt % to about 20 wt % based on the total formulation.

Other Fluid Agents

In some more specific examples, in addition to the fusing agent and the treatment agent, there may be other fluid agents used, such as coloring agents, detailing agents or the like. A coloring agent may include a liquid vehicle and a colorant, such as a pigment and/or a dye. On the other hand, the three-dimensional printing system can include a detailing agent. The detailing agent can include a detailing compound. The detailing compound can be capable of reducing the temperature of the particulate build material onto which the detailing agent is applied. In some examples, the detailing agent can be printed around the edges of the portion of the powder that is printed with the fusing agent. The use of a detailing agent can increase selectivity between the fused and unfused portions of the powder build material by reducing the temperature of the powder around the edges of the portion to be fused.

In some examples, the detailing compound can be a solvent that evaporates at the temperature of the powder build material. In some cases the powder build material can be preheated to a preheat temperature within about 10° C. to about 70° C. of the fusing temperature of the polymeric build particles. Depending on the type of polymeric build particles used, the preheat temperature can be in the range of about 90° C. to about 200° C. or more. The detailing compound can be a solvent that evaporates when it comes into contact with the powder at the preheat temperature, thereby cooling the printed portion of the powder through evaporative cooling. In certain examples, the detailing agent can include water, co-solvents, or combinations thereof. Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-Methoxy-3-Methyl-1-butanol, isobutyl alcohol, 1,4-butanediol, N,N-dimethyl acetamide, and combinations thereof. In some examples, the detailing agent can be mostly water. In a particular example, the detailing agent can be about 85 wt % water or more. In further examples, the detailing agent can be about 95 wt % water or more. In still further examples, the detailing agent can be substantially devoid of radiation absorbers. That is, in some examples, the detailing agent can be substantially devoid of ingredients that absorb enough radiation energy to cause the powder to fuse. In certain examples, the detailing agent can include colorants such as dyes or pigments, but in small enough amounts that the colorants do not promote fusion of the powder printed with the detailing agent when exposed to the radiation energy.

The detailing agent can also include ingredients to allow the detailing agent to be jetted by a fluid jet printhead. In some examples, the detailing agent can include jettability imparting ingredients such as those in the fusing agent described above. These ingredients can include a liquid vehicle, surfactant, dispersant, co-solvent, biocides, viscosity modifiers, materials for pH adjustment, sequestering agents, preservatives, and so on. These ingredients can be included in any of the amounts described above.

Post-Treatment Agent

The post-treatment agent of the present disclosure is a composition comprising a plant oil.

In a further example the plant oil is argan oil. Argan oil is an extract of the fruit of the Argania spinosa plant endemic to Morocco. It can be processed into a cosmetic grade or an edible grade depending on the processes applied. The argan oil can be by itself or may be in the form of an additive in a composition, such as a haircare or cosmetic product.

In a further example the post-treatment agent can comprise Argania spinosa kernel oil (argan oil), water, cetearyl alcohol, coconut alkanes, behentrimonium chloride, fragrance, ethoxylate d sorbitan ester, phenoxyethanol, caprylyl glycol, citric acid, isopropanol, panthenol (Vitamin B5), coco-caprylate/caprate, hydrolized pea protein, PG-propyl silanetriol, sorbic acid, sodium hydroxide, alcohol, butylene glycol, as well as various plant oils and extracts such as Aloe barbadensis (aloe vera) leaf juice, Helianthus annuus (sunflower) seed oil, Simmondsia chinensis (jojoba) seed oil, formes officinalis (mushroom) extract, Camellia sinensis (green tea) extract, Rosmarinus officinalis (Rosemary) leaf extract, Salvia officinalis (sage) leaf extract.

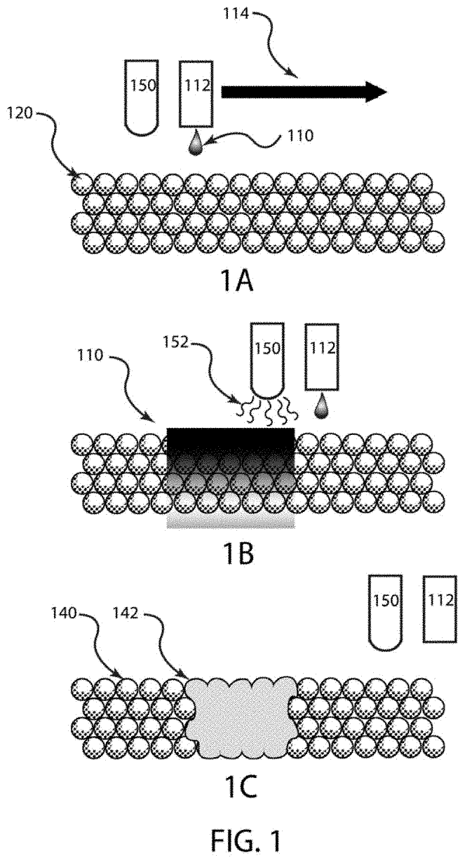

FIGS. 1A-C are an illustration of a possible process of forming the three-dimensional printed object prior to post-treatment with the post-treatment agent. In FIG. 1A, a fusing agent (110) is applied, e.g., jetted, onto a layer of particulate build material (120), which is part of a powder bed, which may include TPA particles. The fusing agent is jetted from a fusing agent ejector (112) that can move across the layer of particulate build material in a given direction of movement (114) to selectively jet fusing agent on areas that are to be fused. A radiation source (150) is also shown, which is described in more detail below.

The system (100) is further described in FIG. 1B, which shows the layer of particulate build material (120) after the fusing agent (110) has been jetted onto an area of the layer that is to be fused. In this figure, the radiation source (150) is shown emitting radiation (152) toward the layer of polymeric build material, which may include the TPA particles. The fusing agent can include any of the radiation absorbers previously described, provided it can absorb this radiation and convert the radiation energy to heat.

FIG. 1C shows a layer of particulate build material (120) with a fused portion (142) where the fusing agent was applied. This portion has reached a sufficient temperature to fuse the particulate build material (including the TPA particles) together to form a solid polymer matrix. For context, the fusing agent ejector (112) and the radiation source (150) are shown in place to apply the next applications of fusing agent and radiation to the next layer of particulate build material applied thereon, to thereby continue to build the three-dimensional object iteratively.

In some examples, a detailing agent or some other agent (not shown) can also be jetted onto the powder bed. The detailing agent, for example, can be a fluid that reduces the maximum temperature of the particles on which the detailing agent is printed. In particular, the maximum temperature reached by the powder during exposure to radiation energy can be less in the areas where the detailing agent is applied. In certain examples, the detailing agent can include a solvent that evaporates from the particles to evaporatively cool the particles. The detailing agent can be printed in areas of the powder bed where fusing is not desired. In particular examples, the detailing agent can be printed along the edges of areas where the fusing agent is printed. This can give the fused layer a clean, defined edge where the fused particles end and the adjacent particles remain unfused. In other examples, the detailing agent can be printed in the same area where the fusing agent is printed to control the temperature of the area to be fused. In certain examples, some areas to be fused can tend to overheat, especially in central areas of large fused sections. To control the temperature and avoid overheating (which can lead to melting and slumping of the build material), the detailing agent can be applied to these areas.

The fusing agent and, in some cases, detailing agent can be applied onto the powder bed using fluid jet print heads, e.g., jetting, inkjetting or ejecting from printing architecture. The amount of the fusing agent used can be calibrated based on the concentration of radiation absorber in the fusing agent, the level of fusing desired for the particles, and other factors. In some examples, the amount of fusing agent printed can be sufficient to contact the radiation absorber with the entire layer of particles. For example, if individual layers of particles are 200 microns thick, then the fusing agent can penetrate 200 microns into the particles. Thus, the fusing agent can heat the particles throughout the layer so that the layer can coalesce and bond to the layer below. After forming a solid layer, a new layer of loose powder can be formed, either by lowering the powder bed or by raising the height of a powder roller and rolling a new layer of powder.

In some examples, the powder bed as a whole can be preheated to a temperature below the melting or softening point of the particles. In one example, the preheat temperature can be from about 10° C. to about 30° C. below the melting or softening point. In another example, the preheat temperature can be within 50° C. of the melting or softening point. In a particular example, the preheat temperature can be from about 160° C. to about 170° C. and the particles can be TPA particles. In another example, the preheat temperature can be about 90° C. to about 100° C., Preheating can be accomplished with a lamp or lamps, an oven, a heated support bed, or other types of heaters. In some examples, the entire powder bed can be heated to a substantially uniform temperature.

The powder bed can be irradiated with a fusing lamp. Suitable fusing lamps for use in the methods described herein can include commercially available infrared lamps and halogen lamps. The fusing lamp can be a stationary lamp or a moving lamp. For example, the lamp can be mounted on a track to move horizontally across the powder bed. Such a fusing lamp can make multiple passes over the bed depending on the amount of exposure needed to coalesce printed layers. The fusing lamp can be configured to irradiate the entire powder bed with a substantially uniform amount of energy. This can selectively coalesce the portions printed with fusing agent leaving the unprinted portions of the particles (e.g., TPA particles) below the melting or softening point.

In one example, the fusing lamp can be matched with the radiation absorber in the fusing agent so that the fusing lamp emits wavelengths of light that match the peak absorption wavelengths of the radiation absorber. A radiation absorber with a narrow peak at a particular near-infrared wavelength can be used with a fusing lamp that emits a narrow range of wavelengths at approximately the peak wavelength of the radiation absorber. Similarly, a radiation absorber that absorbs a broad range of near-infrared wavelengths can be used with a fusing lamp that emits a broad range of wavelengths. Matching the radiation absorber and the fusing lamp in this way can increase the efficiency of coalescing the particles with the fusing agent printed thereon, while the unprinted particles do not absorb as much light and remain at a lower temperature.

Depending on the amount of radiation absorber present in the TPA particles, the absorbance of the radiation absorber, the preheat temperature, and the melting or softening point of the polymer, an appropriate amount of irradiation can be supplied from the fusing lamp. In some examples, the fusing lamp can irradiate individual layers for from about 0.5 to about 10 seconds per pass.

The three-dimensional printed object can be formed by jetting a fusing agent onto layers of powder build material according to a 3D object model. 3D object models can in some examples be created using computer aided design (CAD) software. 3D object models can be stored in any suitable file format. In some examples, a three-dimensional printed object as described herein can be based on a single 3D object model. The 3D object model can define the three-dimensional shape of the article. Other information may also be included, such as structures to be formed of additional different materials or color data for printing the article with various colors at different locations on the article. The 3D object model may also include features or materials specifically related to jetting fluids on layers of particulate build material, such as the desired amount of fluid to be applied to a given area. This information may be in the form of a droplet saturation, for example, which can instruct a three-dimensional printing system to jet a certain number of droplets of fluid into a specific area. This can allow the three-dimensional printing system to finely control radiation absorption, cooling, color saturation, and so on. All this information can be contained in a single 3D object file or a combination of multiple files. The three-dimensional printed object can be made based on the 3D object model. As used herein, “based on the 3D object model” can refer to printing using a single 3D object model file or a combination of multiple 3D object models that together define the article. In certain examples, software can be used to convert a 3D object model to instructions for a three-dimensional printer to form the article by building up individual layers of build material.

In an example of the three-dimensional printing process, a thin layer of particles can be spread on a bed to form a powder bed. At the beginning of the process, the powder bed can be empty because no particles have been spread at that point, or the first layer can be applied onto an existing powder bed, e.g., support powder that is not used to form the three-dimensional object. For the first layer, the particles can be spread onto an empty build platform. The build platform can be a flat surface made of a material sufficient to withstand the heating conditions of the three-dimensional printing process, such as a metal. Thus, “applying individual build material layers of particles to a powder bed” includes spreading particles onto the empty build platform for the first layer. In other examples, a number of initial layers of particles can be spread before the printing begins. These “blank” layers of particulate build material can in some examples number from about 10 to about 500, from about 10 to about 200, or from about 10 to about 100. In some cases, spreading multiple layers of powder before beginning the printing process can increase temperature uniformity of the three-dimensional printed object. A fluid jet printing head, such as an inkjet print head, can then be used to print a fusing agent including a radiation absorber over portions of the powder bed corresponding to a thin layer of the 3D article to be formed. Then the bed can be exposed to electromagnetic energy, e.g., typically the entire bed. The electromagnetic energy can include light, infrared radiation, and so on. The radiation absorber can absorb more energy from the electromagnetic energy than the unprinted powder. The absorbed light energy can be converted to thermal energy, causing the printed portions of the powder to soften and fuse together into a fused layer. After the first layer is formed, a new thin layer of particles can be spread over the powder bed and the process can be repeated to form additional layers until a complete 3D article is printed. Thus, “applying individual build material layers of particles to a powder bed” also includes spreading layers of particles, for example, polyamide-particles, over the loose particles and fused layers beneath the new layer of particles.

Upon completion of the three-dimension printed object the object is still embedded in the powder build material. The particulate build material surrounding the three-dimensional printed object is unfused and able to be removed in a process called de-caking. In some examples, the de-caking is performed in the three-dimensional printer. In other examples, the de-caking is performed in an associated cleaning station. In some of the examples herein, a cleaning station may further include build material processing operations, such as loading a build material store with build material. In other examples herein, the cleaning station may not include the build material processing operations.

The de-caking process may be performed automatically, or semi-automatically. Automatic de-caking may comprise any suitable mechanism for removing non-solidified particulate build material, provided it may be automatically controlled. For example, automatic de-caking may comprise use of laminar or turbulent flow, for example of air, or may comprise vibration, or both; or any suitable mechanism.

Once de-caked the three-dimensional printed object can now be processed through a variety of post-treatments to improve both mechanical properties as well as appearance. One post-treatment for three-dimensional printed parts is a polishing step which is used to decrease the surface roughness of the part and make it smoother.

The current disclosure describes a post-treatment utilizing a treatment agent comprising a plant oil and a heat-treatment step which significantly decreases the surface roughness of the printed object. In the current disclosure the plant oil is argan oil, an extract of the fruit of the Argania spinosa plant endemic to Morocco. In the present disclosure the argan oil may be in the form of a pure oil or as an additive in another composition, such as a haircare or cosmetic product.

The treatment agent can be applied by spraying, soaking or using an application unit, which can include equipment for applying liquids to a three-dimensional printed object.

Spraying the treatment agent can be done via atomization and spraying from a bottle or by use of any known sprayer technology. A spraying unit contains a fluid reservoir and a pump fluidically connected to an outlet nozzle through which the fluid is forced. As an example of the present disclosure a hand-held spray bottle can be used.

In a further example, a liquid application unit can include a tank or well containing liquid for dipping a three-dimensional printed object into or a sprayer (or sprayers) for spraying liquid onto a three-dimensional printed object. In certain examples, a liquid application unit can include a chamber in which a three-dimensional object can be enclosed and sprayers within the chamber can apply the liquid to the three-dimensional printed object. Thus, the term “soaking” may not infer that the three-dimensional object is being bathed in the treatment agent (though it may be), but rather that a coating of treatment agent is applied to and remains on a surface of the three-dimensional object for the time period of the soaking so that the treatment agent can absorb into the surface during the soaking duration.

After application of the post-treatment agent the treated three-dimensional part can be put into a heat-treatment unit for a period of time at an elevated temperature. In some examples of the heat treatment step of the disclosed method, the three-dimensional printed object can be transferred to a curing or heat-treatment unit after formation and maintained at a curing or heat-treatment temperature for a designated period of time, depending on the specific particulate build materials employed, the dimensions of the three-dimensional printed object, etc. In some cases, the three-dimensional printed object can be cured or heat-treated in a heated print bed or chamber of a 3D printing system. In other examples the three-dimensional printed object can be placed in a separate heat-treatment unit. In some examples, the heat-treatment process can be performed at a temperature of from about 140° C. to about 180° C. However, this can depend on the particular materials being employed. For example, it is noted that the heat-treatment temperature can generally be lower than a melting temperature of the three-dimensional printed object. For example, polyamide-12 powder can have a melting temperature of about 187° C. However, after forming a 3D printed article with the polyamide-12, the three-dimensional printed object can have a lower melting temperature of about 177° C. Thus, the heat-treatment temperature can be lower than the melting temperature of the three-dimensional printed object, rather than of the powder bed material. In some examples, the heat-treatment temperature can be from about 140° C. to about 160° C. or from about 150° C. to about 155° C.

Where heat-treatment is employed, the three-dimensional printed object can generally be maintained at the heat-treatment temperature for a period of from about 30 minutes to about 72 hours. In some specific examples, the 3D printed article can be maintained at the heat-treatment temperature for a period of from about 30 minutes to about 4 hours, from about 2 hours to about 10 hours, from about 8 hours to about 20 hours, from about 10 hours to about 30 hours, from about 20 hours to about 40 hours, from about 30 hours to about 50 hours, from about 40 hours to about 60 hours, or from about 50 hours to about 72 hours.

After application of the post-treatment agent to the three-dimensional printed part, the 3D printed part can be set aside at room temperature for a period of time prior to being placed in the heat-treatment unit. In one example the treated three-dimensional printed part sits for an hour at room temperature prior to being placed in the heat-treatment unit.

In the present disclosure the heat-treatment unit can be any known means of bringing the temperature of the three-dimensional printed object to an elevated temperature and holding it at that temperature for a certain length of time. This can include but is not limited to a forced-draft oven, an explosion-proof oven, a vacuum oven or an annealing oven.

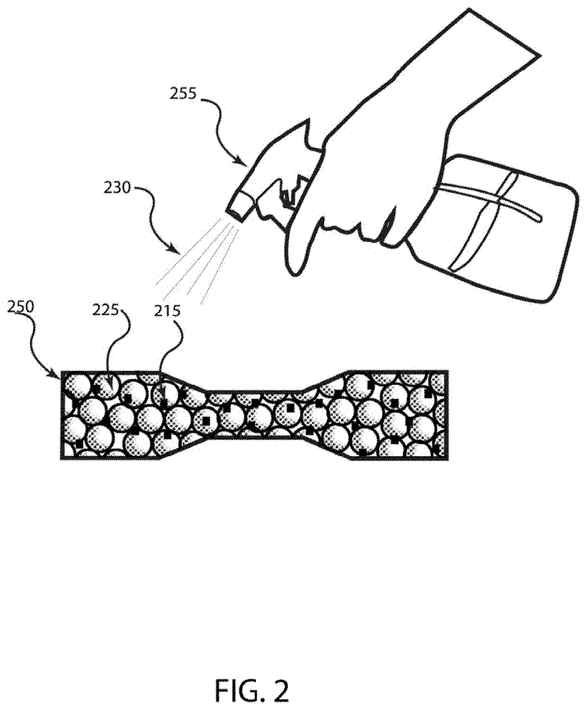

FIG. 2 illustrates an example where the three-dimensional printing method described herein is used to prepare a three-dimensional printed object. In this example, the three-dimensional printed object (250) is shown as being treated with the post-treatment agent (230) in the form of a spray applied from a sprayer (255). The three-dimensional printed object (250) is made up of fused polymeric polyamide particles (225) and radiation absorber particles (215) embedded among the fused polyamide particles (225).

Three-Dimensional Printed Object

The present disclosure also describes three-dimensional printed objects comprising a polymeric body including fused polymeric particles having a radiation absorber embedded as particles among the fused polymeric particles and a post-treatment agent applied to a surface of the polymeric body wherein the post-treatment agent comprises a plant oil.

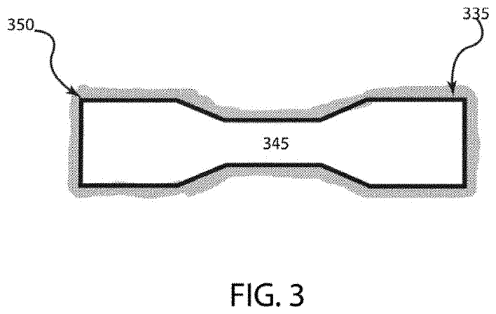

A three-dimensional printed object prepared using the three-dimensional printing kits and/or methods described herein is shown in FIG. 3 (350), For example, a three-dimensional printed object can include a polymeric body (345) including fused particles having radiation absorber embedded as particles among the fused polymer particles (see FIG. 1 for fused polymer particles and radiation absorber). The three-dimensional printed object can also include a post-treatment agent applied to a surface of the polymeric body (335). In one example the applied post-treatment agent may penetrate into the surface of the three-dimensional printed object. The treatment agent can comprise a plant oil.

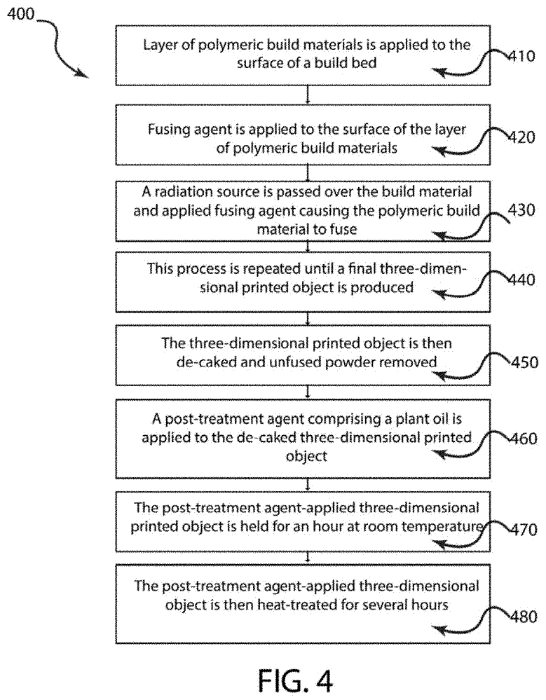

FIG. 4 is an example of a three-dimensional printing method and post-treatment method of the present disclosure (400). In this example a layer of polymeric build material is applied to the surface of a build bed (410) followed by the application of a fusing agent (420). Following the application of a fusing agent a radiation source is passed over the build bed thus fusing the polymeric build particles together (430). This process is repeated (440) until a final three-dimensional printed object is produced. Subsequently the three-dimensional printed object is separated from unfused particulate build materials in a process called de-caking (450). After the three-dimensional printed object is de-caked it can be treated with the post-treatment agent comprising a plant oil (460) by any means known in the art. In one example the application of the post-treatment agent can be accomplished by the use of a sprayer. The treated three-dimensional printed object, in another example, may be held for an hour at room temperature (470). Finally, the treated three-dimensional printed part is then placed in a heat-treatment unit (480) and held at an elevated temperature for several hours after which it is removed and allowed to return to room temperature.

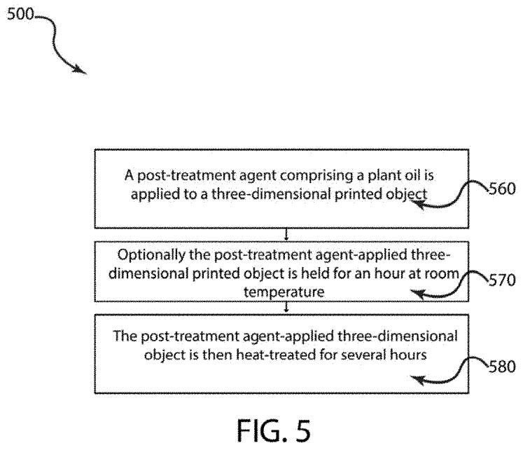

FIG. 5 is an example of an implementation of the post-treatment method of the present disclosure (500), In this example a three-dimensional printed object is treated with the post-treatment agent comprising a plant oil (560). In one example the application of the post-treatment agent can be accomplished by the use of a sprayer. The treated three-dimensional printed object, in an example, may be held for an hour at room temperature (570). Finally the treated three-dimensional printed part is then placed in a heat-treatment unit (580) and held at an elevated temperature for several hours after which it is removed and allowed to return to room temperature.

Three-Dimensional Printing Kit

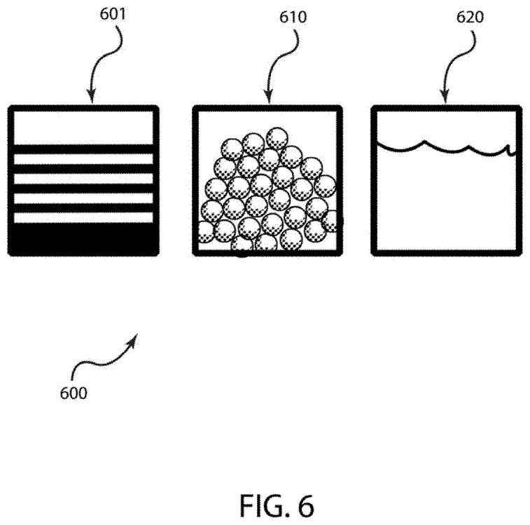

The present disclosure also describes three-dimensional printing kits. The kit can include any of the materials used in the methods and in forming the three-dimensional printed objects described herein. In some examples, the kit may comprise any particulate build material described herein, any fusing agent described herein and any post-treatment agent described herein. FIG. 6 shows a schematic illustration of one example three-dimensional printing kit (600) in accordance with examples of the present disclosure. The kit includes a fusing agent (601), a particulate build material (610) and a post-treatment agent (620). In an example the particulate build material comprises a polymer selected from the group consisting of thermoplastic amide and polyamide. The fusing agent may comprise a radiation absorber. The post-treatment agent comprises a plant oil. In some example the plant oil comprises argan oil.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one example within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, “applying” when referring to a fluid agent, such as a fusing agent that may be used, for example, refers to any technology that can be used to put or place the fluid, e.g. fusing agent, post-treatment agent, or other fusing agent onto a layer of particulate build material for forming a three-dimensional object. For example, “applying” may refer to a variety of dispensing technologies, including “jetting,” “ejecting,” “dropping,” “spraying,” or the like.

As used herein, “jetting” or “ejecting” refers to the expulsion of fluid agents or other compositions from ejection or jetting architecture, such as ink-jet printheads. Such architecture can be configured to print varying drop sizes such as up to about 20 picoliters, up to about 30 picoliters, or up to about 50 picoliters, etc. Example ranges may include from about 2 picoliters to about 50 picoliters, or from about 3 picoliters to about 12 picoliters.

As used herein, a plurality of items, structural elements, compositional elements, and/or materials may be presented in a common list for convenience. However, these lists should be construed as though an individual member of the list is identified as a separate and unique member. Thus, no individual member of such list should be construed as a de facto equivalent of any other member of the same list based on presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following examples illustrate the present disclosure. However, it is to be understood that the following are merely illustrative of the application of the principles of the present disclosure. Numerous modifications and alternative devices, methods and systems may be devised without departing from the spirit and scope of the present disclosure. The appended claims are intended to cover such modifications and arrangements.

### Example 1 Control

Several sample three-dimensional objects were printed in the shape of “dogbones” using an HP Multi-jet Fusion 3D® Printer. The build material was TPA powder and the fusing agent included carbon black pigment as a radiation absorber.

Once printed and decaked the TPA three-dimensional printed dogbones were exposed to a variety of treatment options as shown in the table below.

| | | | Heat- |
|---|---|---|---|
| | Treatment | Heat- | Treatment |
| | Formulation | Treatment | Temperature |
| Sample ID | Applied | Time (h) | (° C.) |
| TPA Control | None | 0 | n/a |
| TPA Heat Control | None | 20 | 153 |
| TPA-P | Purador 100% | 20 | 153 |
| | Argan Oil | | |
| TPA-AN | Art Naturals Hairspray | 20 | 155 |
| | with Argan oil | | |
| TPA-HSI | HSI hairspray with | 20 | 155 |
| | Argan Oil | | |
| TPA-Si | Silicone oil spray | 20 | 153 |
| (comparative) | (no argan oil) | | |

### Example 2 Heat-Treatment of the Samples

The samples from Example 1 were then placed in a heat-treatment unit after sitting for an hour and held at 153° C. for 20 hours. Upon completion of the heat-treatment step the samples were removed and allowed to cool to room temperature.

The surface roughness of the samples was then characterized using a Mitutoyo Surftest SJ210 portable surface roughness tester (Mitutoyo America Corp., Los Angeles, Calif.). The average roughness (Ra) was measured according to EN ISO 4287 standard. Ra is defined as the arithmetic mean of the absolute values of the profile deviations from the mean line of roughness of the part. It is measured in units of microns (μm). For each dogbone the top surface and the bottom surface roughness was measured. The results are summarized in the table below.

| Sample ID | Ra (TOP) (μm) | Ra (BOTTOM) (μm) |
|---|---|---|
| TPA Control | 13.66 | 11.119 |
| TPA Heat Control | 13.097 | 12.733 |
| TPA-P | 8.991 | 3.149 |
| TPA-AN | 1.307 | 0.395 |
| TPA-HSI | 1.662 | 0.451 |
| TPA-Si (comparative) | 11.203 | 14.552 |

As can be seen from the data those samples which were treated with formulations containing argan oil (TPA-P, TPA-AN, TPA-HSI) all showed extensive decreases in surface roughness (Ra) compared to the Control and the Heat Control. In addition a comparative example of a silicone oil-based spray without argan oil showed much less improvement in surface roughness.

What is claimed is:

1. A three-dimensional printed object, comprising:
a polymeric body including fused polymeric particles having a radiation absorber embedded among the fused polymeric particles;
and a post-treatment agent applied to the three-dimensional printed object, wherein the post-treatment agent comprises a plant oil.

2. The three-dimensional printed object of claim 1, wherein the polymeric particles are selected from a group consisting of thermoplastic amide and polyamides.

3. The three-dimensional printed object of claim 1, wherein the three-dimensional printed object includes the radiation absorber in an amount from about 0.005 wt % to about 5 wt % with respect to the total weight of the three-dimensional printed object.

4. The three-dimensional printed object of claim 1, wherein the three-dimensional printed object with an applied post-treatment agent has been heat-treated at a temperature of about 155° C. for a period of time of about 10 hours to 20 hours.

5. The three-dimensional printed object of claim 1, wherein the plant oil comprises argan oil.

6. A method for treatment of a three-dimensional printed object resulting in reduced surface roughness comprising the application of a post-treatment agent comprising a plant oil and heat-treating the three-dimensional printed object at an elevated temperature.

7. The method of claim 6 in which the plant oil comprises argan oil.

8. The method of claim 6 in which the post-treatment agent comprising a plant oil is applied to the three-dimensional printed object by spraying directly onto the surface.

9. The method of claim 6 in which the post-treatment agent comprising a plant oil is applied to the three-dimensional printed object by immersing the three-dimensional printed object in a bath of the post-treatment agent.

10. The method of claim 6 in which the post-treatment agent comprising a plant oil is applied to the three-dimensional printed object in an amount between 0.01 wt % and 10 wt % based on the total weight of the three-dimensional printed object.

11. The method of claim 6 in which the heat-treatment takes place at a temperature between 100° C. and 155° C. for a length of time between 15 hours and 25 hours.

12. The method of claim 6 in which the heat-treating takes place at a temperature between 150° C. and 155° C. for a length of time of about 20 hours.

13. The method of claim 6 in which the three-dimensional printed object is placed in the heat-treatment up to 1 hour after the application of the post-treatment agent to the three-dimensional printed object.

14. A three-dimensional printing kit comprising:
a fusing agent comprising a radiation absorber;
a particulate build material comprising polymeric particles comprising a polymer selected from thermoplastic amide and polyamide;
and a post-treatment agent comprising a plant oil.

15. A three-dimensional printing kit of claim 14 wherein the plant oil comprises argan oil.
